(19) United States
(12) Patent Application Publication
(10) Pub. No.: US 2009/0276500 A1
(43) Pub. Date: Nov. 5, 2009

(54) MICROBLOG SEARCH ENGINE SYSTEM AND METHOD

(76) Inventor: Amit Vishram Karmarkar, Palo Alto, CA (US)

Correspondence Address: Raj Abhyanker LLP, 1580 West, El Camino Real, Suite 8, Mountain View, CA, 94040, US

(21) Appl. No.: 12/503,088

(22) Filed: Jul. 15, 2009

Related U.S. Application Data
(63) Continuation-in-part of application No. 11/231,575, filed on Sep. 21, 2005, now Pat. No. 7,580,719.
Application No. 11/231,575 is a continuation-in-part of application No. 11/519,600, filed on Sep. 11, 2006, now Pat. No. 7,551,935.
Application No. 11/519,600 is a continuation-in-part of application No. 12/422,313, filed on Apr. 13, 2009.
(60) Provisional application No. 61/161,763, filed on Mar. 19, 2009.

(51) Int. Cl. G06F 15/16; G06F 17/30

(52) U.S. Cl. 709/206; 707/3; 707/E17.108; 707/E17.032

(57) ABSTRACT

A method, system and an apparatus of Microblog Search Engine and method are disclosed. In one aspect, a computer implemented method includes accessing a Short Message between a Broadcaster and a follower through a first Microblog Server and processing the Short Message through a Microblog Search Engine. The processing of Short Message further includes parsing the Short Message with the Microblog Search Engine, generating a Context Metadata of the Short Message, associating explicitly the Context Metadata to the Short Message. In addition the method includes, delivering the Short Message and the Context Metadata to a Requestor through the Microblog Search Engine.

### CLAIMS OF PRIORITY

This is a continuation in part application and claims priority from U.S. Utility Applications: application Ser. No. 11/231,575, filed on Sep. 21, 2005, application Ser. No. 11/519,600 filed on Sep. 11, 2006, application Ser. No. 12/422,313 filed on Apr. 13, 2009, and Provisional Application No. 61/161,763 filed on Mar. 19, 2009.

### FIELD OF TECHNOLOGY

This disclosure is in the field of Short Message search technology, and more specifically, to a system, apparatus and method of microblog Short Message search.

### BACKGROUND

A blog (e.g., weblog) may be a shared on-line journal where users can post diary entries about their experiences, opinions and/or interests. A user may publish information on the blog. However, patrons (e.g., fans of the user publishing information of the blog) may not be notified of new information posted on the blog. As a result, new posts on the blog may not reach an audience that may be interested in content of a recent post in a timely manner. Therefore, the user may not have enough incentive to write posts on the blog on a frequent basis. In addition, the patrons may need to invest significant amounts of time to read posts because some posts may carry on for a number of paragraphs. Therefore, the utility of blogs as a mode to communicate information to an audience of patrons may be limited.

Furthermore, discovery of recent posts made by the user and other users may be limited. Search engines (e.g., Yahoo®, Google®) may not adequately index information quickly enough to capture recent posts on the blogs. This may be especially true when the frequency of posts is very high (e.g., multiple times a day). Therefore, target audiences may not discover highly relevant content.

For example, members of a political group may wish to express their thoughts to fellow supporters. However, the messages posted on the blogs of the members may not disseminate quickly enough to supporters. For example, time may be of the essence when organizing political rallies, or impromptu meetings between supporters. As such, supporters may not be able to quickly organize and/or physically meet to foster change. Therefore, democratic voices may be muted

### SUMMARY

A method, system and an apparatus of microblog search engine and method are disclosed. In one aspect, a computer implemented method includes accessing a Short Message between a Broadcaster and a Follower through a first microblog Server and processing the Short Message through a microblog Search Engine. The processing of Short Message further includes parsing the Short Message with the microblog Search Engine, generating a Context Metadata of the Short Message, associating explicitly the Context Metadata to the Short Message. In addition the method includes, delivering the Short Message and the Context Metadata to a Requestor through the microblog Search Engine.

In another aspect, a microblog search application includes a first interface configured to facilitate composition of a message by a requesting user. The microblog search application also includes logic to automatically generate a search query based on the message. In addition, the Microblog search engine also includes a second interface configured to display search results relating to the search query and receive selections of the search results from the user. The microblog search application automatically incorporates, in response to the selections, the selected ones of the search results into the message in the first interface.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE VIEWS OF DRAWINGS

Solid Lines Indicate Developments within an Element; Dashed Lines Indicate Information and Action being transmitted between Elements. Example embodiments are illustrated by way of example and not limitation in the figures of the accompanying drawings, in which like references indicate similar elements and for which:

FIG. 1 is a diagram of the process for a particular SM through the SMS. A Short Message (SM), is sent from the Broadcaster [1] to a Microblog server[3], where the SM passes through a Parser [5], then through a Context Associator (7) that associates and makes explicit at the user-level the contextual information associated with the SM, then in the preferred embodiment, before the SM is sent to the Follower [18], takes the optional additional operation through a Comparative Analyzer [9] that matches and incorporates this SM with a database [11] that contains both previous SMs [13] naming a User (Broadcaster or Follower) and, for each User, patterns [15a, Broadcasters and 15b, Followers] derived from analysis of each SM's context, according to one embodiment.

FIG. 2 is a diagram of a further process where the comparative analyzer searches through the database [11] that also includes third-party offers [23], optionally differentiating between assistive [23a] or contextually-relevant [23b] offers, and upon finding any such, generates and sends to each of Broadcaster and Follower a follow-on message incorporating that offer (respectively, [25] and [27]), according to one embodiment.

FIG. 3 is a diagram of a further embodiment where the Microblog server [3] periodically reviews for each User, who may be either or both Broadcaster or Follower, the SMS Database [11] containing previous SMs [13], and, for each SM found naming that User [34], passes the SM through a Text Analyzer [35] that analyzes the SM for an uncompleted commitment [36]; upon finding such, matches the SM's context to the current date [37] and according to a schedule [39], generates a follow-up message [40] to the responsible but non-acting party [42], according to one embodiment.

FIG. 4 is a diagram of an SMS containing multiple comparative analyzers, each comparative analyzer incorporating a particular cultural norm (Culture A, Culture B, and Culture C, and [49a], [49b], [49c], respectively), where the database [11] also contains for each User a record of that User's default cultural norm (‘Default’) [15c], according to one embodiment.

FIG. 5 is a diagram of the process for what happens when the SMS identifies a clash between the default cultural norms of Broadcaster [61] and Follower [63]. An additional Default Clash Note indicating both the existence of the clash and of the Broadcaster's Default [54a] is associated with the SM sent to the Follower [18], while a reciprocal Default Clash Note indicating both the existence of the clash and of the Follower's Default [54b] is returned to the Broadcaster [59], according to one embodiment.

FIGS. 6 and 7 are a diagram of the process for an immediate-range, face-to-face interaction set. In FIG. 6 the first SM is sent at short range from Broadcaster's unit [71] to Follower's unit [73] directly. The SMS software detects the face-to-face mode [74] and links the two users' unique IDS to the SM [76], leaves a copy of the SM with a unique ID link on the each of the Broadcaster's unit [75] and Follower's unit [77]; and enters the other unit's unique ID onto a list of ‘current contacts’ for that unit (Broadcaster's unit's list, [78]; Follower's unit's list, [79]). Thus, the Broadcaster's unit will include the Follower's ID, and the Follower's unit will include the Broadcaster's ID. After this exchange Broadcaster and Follower part company for some time, according to one embodiment.

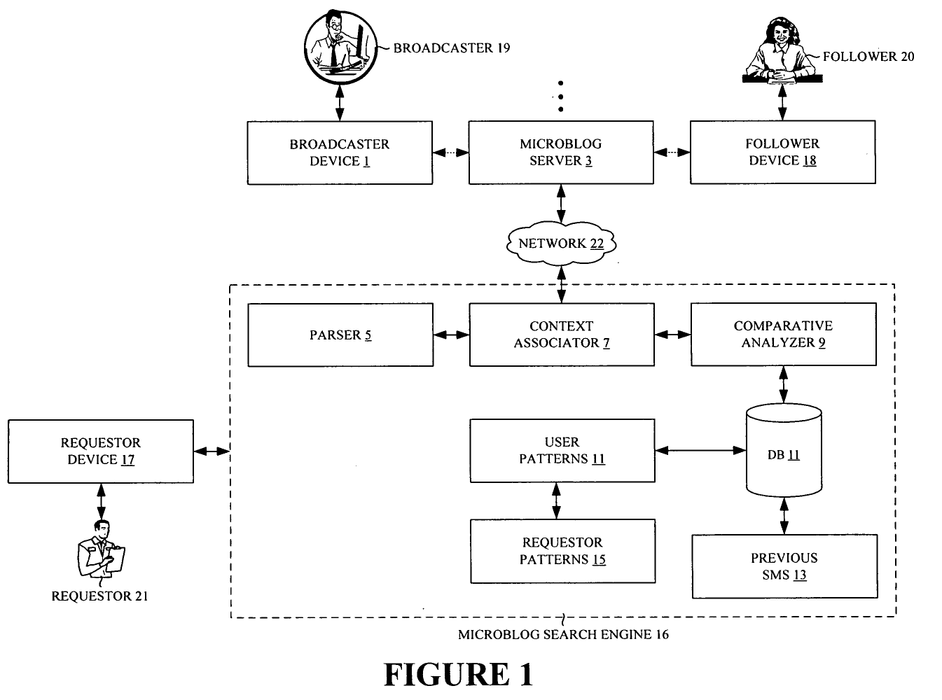

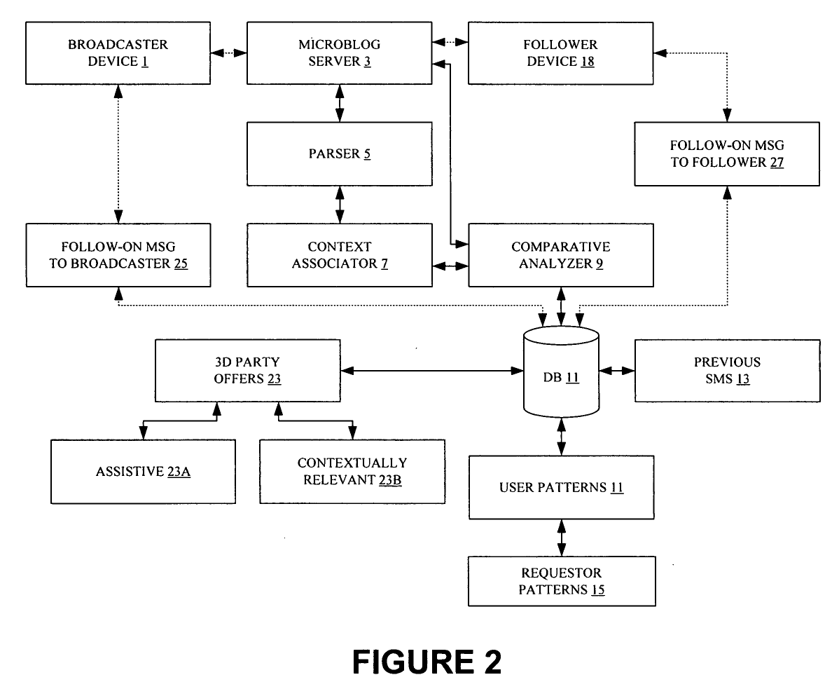

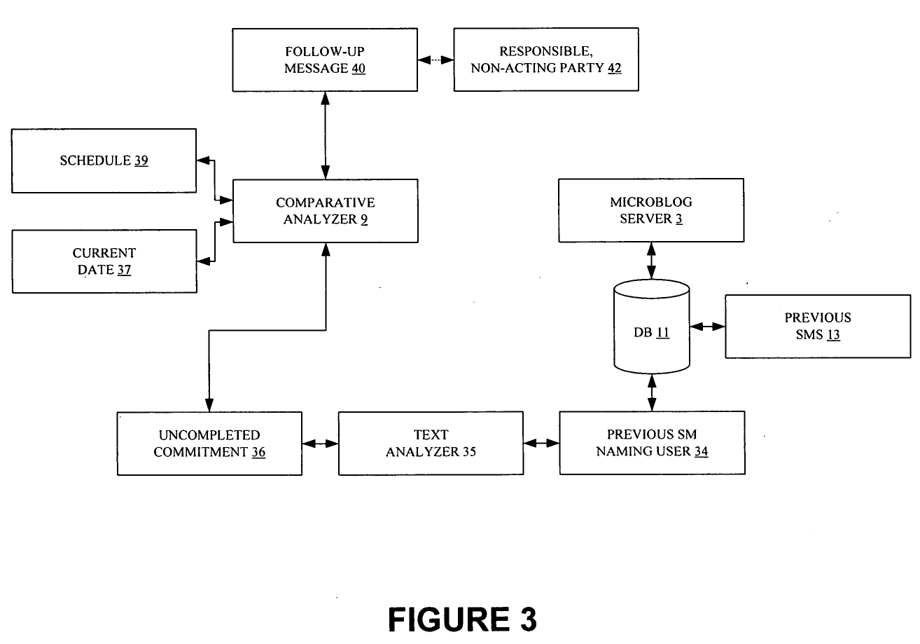

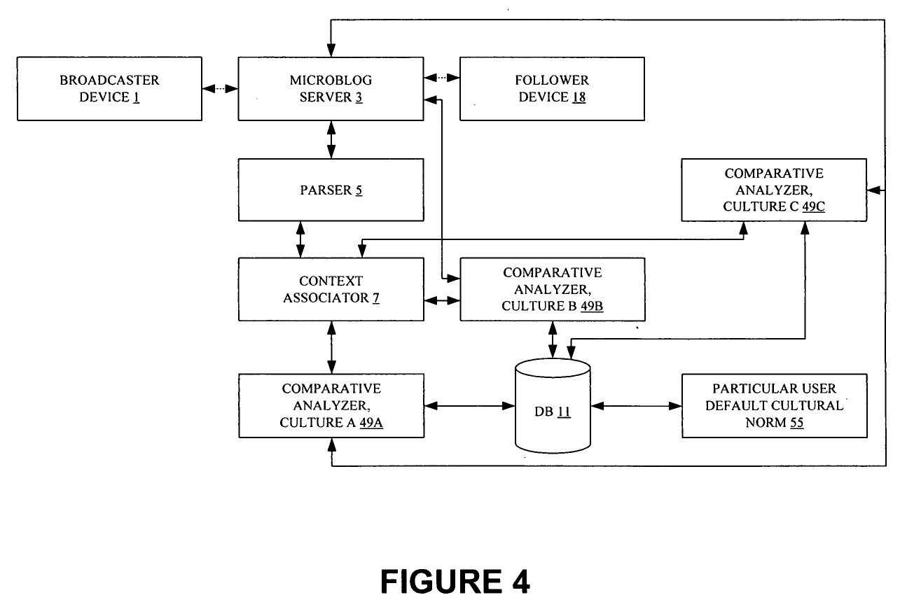

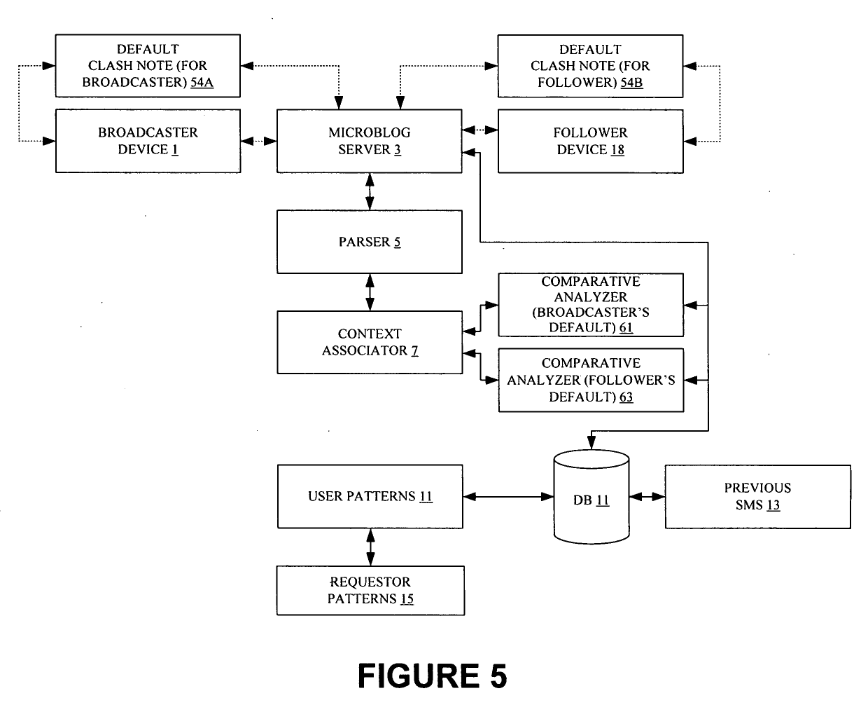

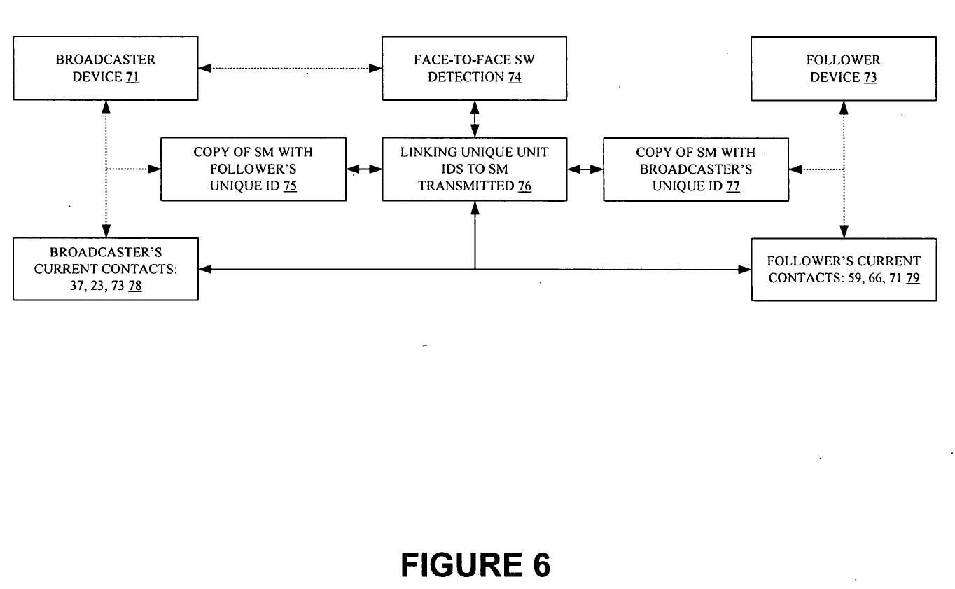

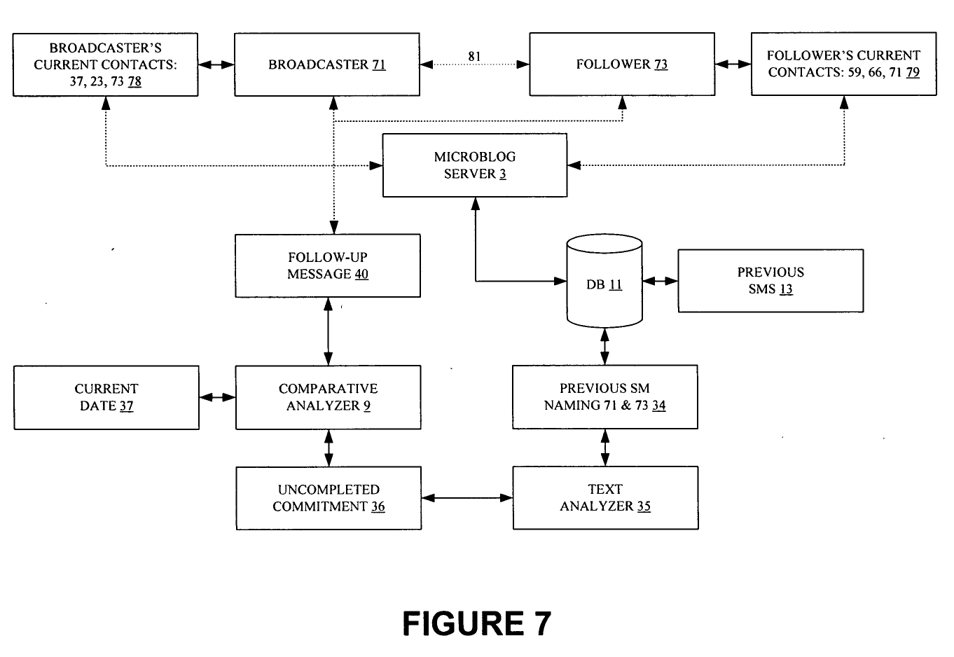

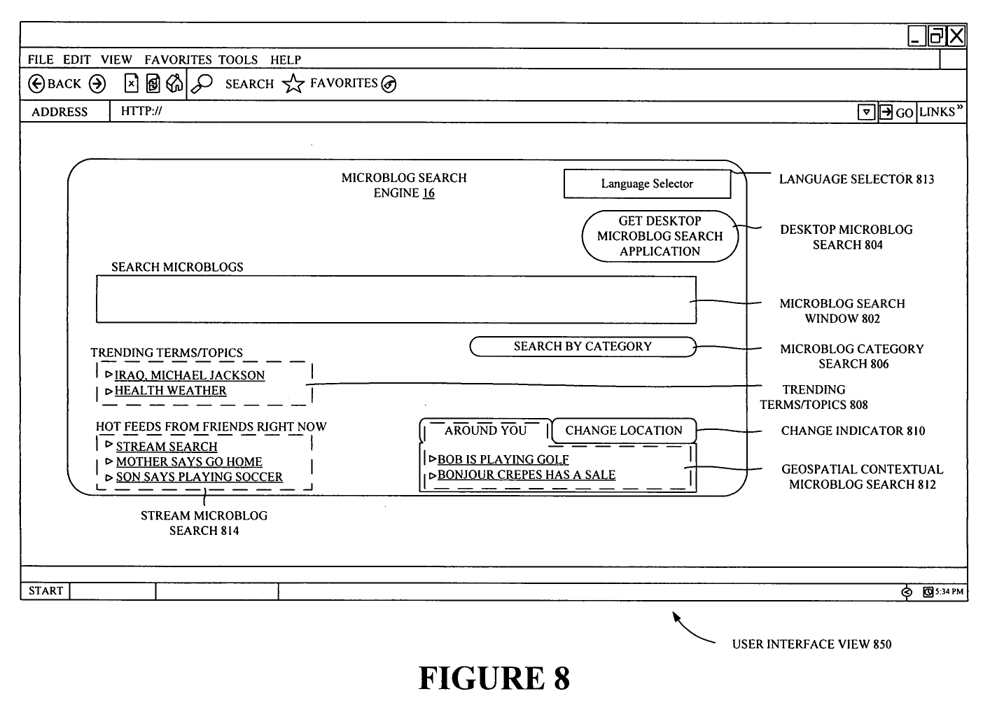

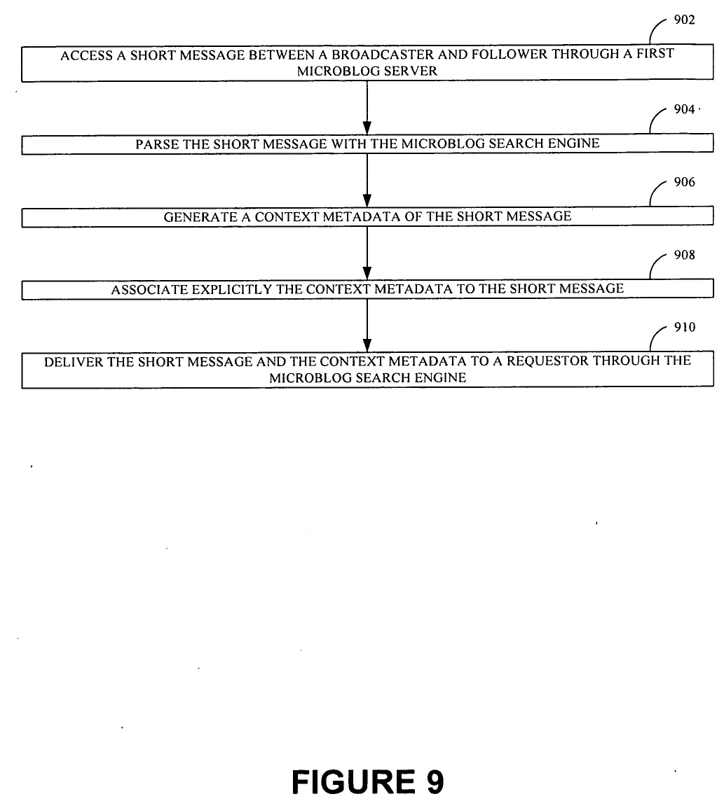

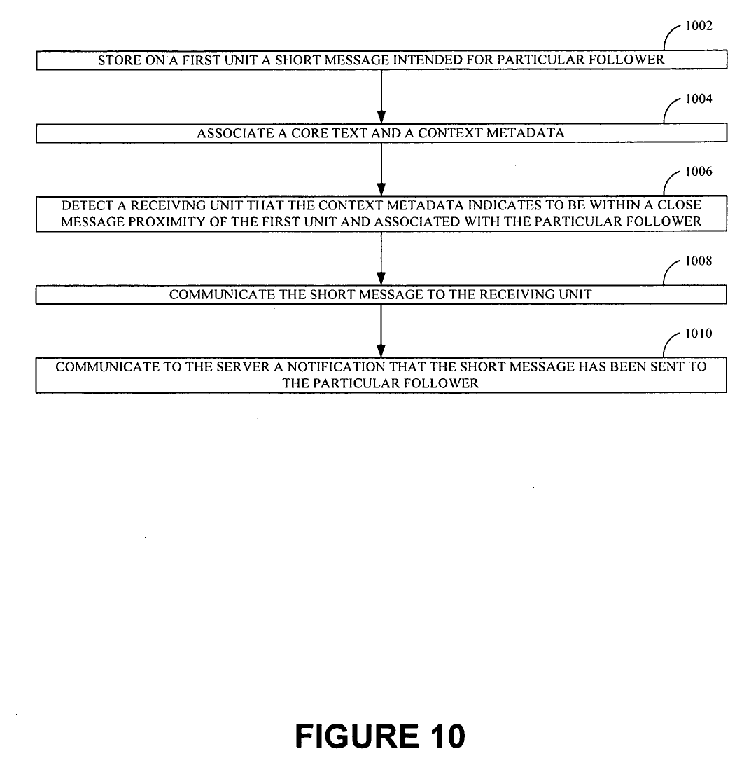

When, as shown in FIG. 7, the Broadcaster's Unit [71] and Follower's unit [73] once more come within immediate-range, face-to-face co-locality, the units use standard detection software such as Bluetooth to become alerted to each others' presence [81]. Each unit compares the now-present unique unit ID against its list of current contacts [78, 79]; and upon finding a match (indicated by bold lettering in the drawing), sends the original message to the Microblog Server[3], which both handles the SM as disclosed in FIGS. 1-2 and also examines the SMS Database [11] containing previous SMs [13], and, for each SM found naming that pair of now-present unique unit IDS, passes the SM through a Text Analyzer [35] that analyzes the SM for an uncompleted commitment [36]; upon finding such, matches the SM's context to the current date

and generates a follow-up message [40] to both Broadcaster [73] and Follower [73], according to one embodiment.

FIG. 8 is a diagram of a further embodiment that shows a user interface view [850] of the Microblog Search Engine [16]. The user interface features a search filed wherein a user may choose to type a word or phrase into microblog search window [802]. Once typed, the user may press a key on the keyboard (e.g., the “enter” key) and then be shown a list of microblog posts related to the search term. A user may alternatively elect to search microblog posts by category, in which case the user could, for example, click a button on the screen, (e.g., the microblog search) button [806] and may then be shown a preselected list of categories chosen by the Microblog Search Engine [16]. Alternatively, a user may select to display microblog posts related to topics that are currently preselected as trends by the Microblog Search Engine [16] by clicking the another button, (e.g., Trending Terms/Topics) button [808]. Another user option allows the user to access microblog posts that are determined by Microblog Search Engine [16] to be the most popular topics by clicking the Stream Microblog Search button [814]. An additional user option may allow users to search topics based on their geographic location by clicking another button (e.g., the Geospatial Contextual Microblog Search) button [812]. With another additional feature, a user may elect to move from the User Interface View [850] to an available, installable desktop microblog search, but clicking another button, (e.g., the Desktop Microblog Search) button [804]. In an additional feature, a user may elect to search and view searches relative to one or more different languages by clicking another button (e.g., the Language Selector) button [816].

FIG. 9 is a process flow that illustrates processing the short message through a microblog search engine, according to one embodiment.

FIG. 10 is a process flow that illustrates sending a short message to a follower, according to one embodiment.

Other features of the present embodiments will be apparent from the accompanying Drawings and from the Detailed Description that follows.

### DETAILED DESCRIPTION

A method, system, and an apparatus of Microblog search engine and method are disclosed. In the following description, for the purposes of explanation, numerous specific details are set forth in order to provide a thorough understanding of the various embodiments. It may be evident, however, to one skilled in the art that the various embodiments may be practiced without these specific details.

According to one embodiment, a Short Message sharing system is disclosed as illustrated in FIG. 1. Particularly, a microblog server 3 as illustrated in FIG. 1 (e.g., a microblog Server). A microblog may be a form of multimedia authoring whereby users may send brief text updates (e.g., Short Messages) or micro media updates such as photos or audio clips and publish them, either to be viewed by anyone or limited to a particular group chosen by the user. These Short Messages may be submitted by a variety of means, including instant messaging, text messaging, digital audio, email or the web. A single microblog message entry may consist of a single sentence or a fragment of a sentence, or even an image or brief video. The microblog server 3 in FIG. 1 may enable a broadcaster 1 (e.g., a user of the microblog server 3 that authors information) as shown in FIG. 1 to generate a Short Message that is displayed in a profile of the user. The Short Message may be defined as a text message limited to a number of characters (e.g., 140-160 characters). For example, the short message may be a communication made by the broadcaster 1 through a mobile device, laptop, and/or other form of a data processing system. A search engine may be a tool designed to look for information on the World Wide Web or other source of data. Search results may be presented in a list which may be referred to as, “hits”. Information contained in the search may consist of information, web pages, images or other types of files. The search engine may also mine data available to it via sources of data such as databases or directories. The search engine may operate algorithmically, with human input or with a combination of both.

The Short Message may indicate a present sense impression of the broadcaster 1 of FIG. 1. For example, short message may include information about what is happening presently around the broadcaster 1 of FIG. 1. Alternatively, the Short Message may indicate a mental thought of the broadcaster 1, such as what the broadcaster 1 is presently thinking about as communicated (e.g., by manually typing in text characters on the mobile device) by the broadcaster 1 using the limited number of characters set by the microblog server 3 of FIG. 1.

The microblog server 3 of FIG. 1 may enable the broadcaster 1 to share the Short Message to any number of followers 18 of the broadcaster 1. Followers 18 of the broadcaster may be users of the microblog server 3 that subscribe to a feed of the broadcaster 1. The broadcaster 1 may receive an electronic communication (e.g., an email) when a new follower (e.g., of the followers 18) indicates that they wish to desire notifications when the broadcaster 1 publishes a new Short Message on the microblog server 3.

The broadcaster 1 may be able to ‘block’ or prevent access by the new follower to messages created and published by the broadcaster 1 by indicating this through a preference of the microblog server 3 (e.g., a ‘no follow’ button). In addition, the followers 18 may be able to respond to specific Short Messages made by the broadcaster 1 through direct response to the broadcaster (e.g., in which only the broadcaster 19 receives the response) and/or through a broadcast response. The broadcast response may directly be published on a page of the particular follower generating the broadcast response. Followers of the particular follower may then receive the broadcast response. For example, a particular follower may ‘comment’ on a message of the broadcaster 19 by responding directly to that message through a respond indicator (e.g., a respond button) associated with the message.

The followers 18 may receive the Short Message within seconds of the authoring of the Short Message by the broadcaster 19. For example, the followers 18 may receive the Short Message on their mobile telephones, PDAs, and/or computers through SMS (e.g., Short Message Service) circuit switched networks and/or through Internet based protocols.

Also illustrated in FIG. 1 is a Microblog search engine 16, according to one embodiment. The Microblog search engine 16 may be able to search Short Messages posted by broadcasters (e.g., such as the broadcaster 19) in any number of the microblog server 3. For example, the microblog server 3 may include an Application Programming Interface (API) that enables developers to create their own versions of the microblog server 3 with differing levels of functionality. For example, one type of variant may enable the sharing of multimedia content in addition to Short Messages (e.g., pictures, videos). Each of these variant microblog servers may leverage and/or republish Short Messages to/from a parent microblog server 3.

The Microblog search engine 16 is illustrated as including a parser 5, a context associator 7, a comparative analyzer 9, a database 11, and previous messages 13. The Microblog search engine 16 may be a server side application that is accessible as a website in which a searching user may discover recently posted Short Messages based on contextual information. In alternate embodiments, the Microblog search engine 16 may be a client side application accessible as an executable file (e.g., a downloadable file) in which Short Messages generated by any number of the microblog server 3 are displayed on a desktop of a user as they occur (e.g., a desktop of a mobile device and/or a personal computer).

For example, the Microblog search engine 16 may enable the searching user to discover recently posted Short Messages by the broadcaster 1 and/or broadcast response by the followers 18. Alternatively, contextual information, such as location of a particular mobile device that generated the Short Message may be displayed through the microblog search engine 16. This information may be provided through a global positioning meta-data provided by the mobile device when the Short Message is communicated to the microblog server 3.

According to another embodiment, the Microblog search engine 16 may enable the searching user to bookmark favorite search topics associated with recently posted Short Messages by broadcasters 1 and followers 18. Once bookmarked, favorite search topics may be tracked by the searcher by indicating this through a preference of the microblog server 3 (e.g., a ‘Save & Track’ button).

For example, the Microblog search engine 16 may enable the searching user to track recently posted messages that include search terms related to the election in Iran by indicating this preference through the microblog server 3. Recently broadcasted responses regarding this and contextually related search terms (e.g., ‘president of Iran’, or ‘Mousavi’, or ‘Ahmadinejad’) may be displayed through the microblog search engine 16.

Furthermore, a systematic analysis algorithm may be applied through the microblog server 3 that applies a library of context data to the search term. This library of context data may automatically recommend and may automatically associate the recommended terms to the search term. Through this process, search queries may return matches for both the search term and recommend search terms. Contextual information may be language based, cultural based, and/or temporally based.

For example, the Microblog search engine 16 might apply a library of context data applicable to the Spanish language such that it enables a searcher to generate a search regarding public opinion on immigration policy among Spanish speakers. The Microblog search engine 16 may automatically recommend and may automatically associate recommended terms such as, “el plan inmigratorio” with such a search.

Cultural based contextual information may be available to searchers as well via an algorithm applied through the Microblog search engine 16. Microblog server 3 may contain a library of context data applicable to certain colloquial phrases popular to a given language or culture. For example, a broadcaster might enter a Short Message that says, “John McCain is no spring chicken”. If a searcher wanted to access recent public opinion on that politician's age, the microblog server 3 may access the cultural library and recognize “spring chicken” as a colloquial phrase used in the United States to describe a person's age.

The microblog server 3 may also have available a geographically based set of contextual information with which it can analyze search queries. Contextual information related to location of a particular mobile device that generated the Short Message may be displayed through the microblog search engine 16. This information may be provided through a global positioning meta-data provided by the mobile device when the Short Message is communicated to the microblog server 3. When a searcher enters search terms related to a particular location, the microblog search engine 16 may generate search result recommendations relative to broadcasters located in the searched for location. For example, a searcher might want to know what locals think about a particular event. The microblog server may access the searcher's geographical location via the output it receives from the user's broadcasting device. The microblog server may then use this information to recommend searches relevant to that user's location.

Temporally based contextual information may also be available through the library of contextual data and may automatically associate and recommend matches to all results relative to a particular time. Time and date information may be made accessible by whichever device is used in broadcasting a Short Message (e.g., desktop computer, laptop computer or mobile device). When a searcher enters a search term related to a particular time, the microblog search engine 16 may generate a search result relative to broadcasted messages from a particular time.

A Short Message Service (SMS) provides and supports communication linking its users. In every message, the Core Text thereof is only a part of the communication, though it is the element most commonly thought to comprise the communication. For example, the short phrase “I need you” has those three words as its Core Text. That communication communicates both the existence of a need and the existence of a connection between the individuals referenced by the pronouns (who are presumed, in the absence of a mirror and a solipsistic utterance, to be distinct). In a multi-media communication, the accompanying sound and visual image(s) of a communication's Core Text may greatly transform the meaning of the message, emphasizing or even inverting the meaning.

Contextual information associated with each message (its broadcaster, follower(s), time, and format) is another, equally important part of the communication. Contextual information is usually implicit or indicated by subordinate text or structures. For example, if to the previous phrase “I need you” there were an associated follower header of “Dr. Watson” such that the message read: “[To: Dr. Watson] I need you”, then the communication indicates ‘you’ should be bound to ‘Dr. Watson’, while the subject pronoun “I” indicates to whom Dr. Watson should respond (presumably, a person known to or immediately perceivable by Dr. Watson). Adding on a second header indicating the broadcaster, the message becomes more specific: “[From: Alexander Graham Bell] [To: Dr. Watson] I need you”, allows both pronouns to be associated to the intended individual. A great deal of human ingenuity and time has gone into both reducing the need to overtly incorporate contextual information into the Core Text and coping with confusion by explicitly adding just enough to enable an overly contracted communication to be understood. Frequency-differentiation can replace ‘Tower, this is Flight 45 1’ and the every-useful phrase colorfully highlighted by Robert De Niro (“You talkin' to me?”) are respective examples of such adaptations.

Finally, social patterns and situational context associated with each message form a final, and also important, part of each message. For example, the fact that this particular message, “I need you”, took place in a laboratory where the broadcaster and follower were regularly working with dangerous substances, distinguished the message as being one expressing an immediate and particular need for presence, from being one expressing a theoretical or economic statement of condition, or one indicating an emotional valuation of fellowship. One suspects that the tone of voice may also be contextual information relevant to the situational context associated with the message.

A Short Message Service that transmits only the first-mentioned part of a communication-the Core Text-may initially prosper simply due to is users' need to use the SMS even more to establish through explicit Core Text messaging the second and third associational elements. However, this will incur some cost in delay and consequences to the users. (“Did you send that last call?” “Yes I did.” “Did you mean to send it to me?” “Yes, of course-who else is on this line?” “What did you mean by ‘need’, Dr. Bell?” “Aaarrrgh!”)

There is a value to a Short Message Service which can provide and make explicit the contextual and associational information to assist a Core Text message's follower comprehend the meaning of a single Short Message without requiring further intercommunication, a SMS that assists and supports human-centered encoding.

Definitions

Context Metadata Elements of a SM that enable transmission of the Core Text from a broadcaster to one or more followers. These may include the identification of Broadcaster and Follower, the date, time, and location of the original SM; full reciprocal contact information between the Broadcaster and Follower; the priority or ordering of the message; a title, subject or summary reference for the message; or formatting or transmission specific information.

Core Text The actual message (text, image, sound recording, or combination of one or more of the three) carrying the expressed meaning.

Close Message Proximity This is the short-range, direct-transmission distance for a Unit, and depends upon the technology for message transmission in a Unit's hardware. It may be within three meters (e.g. for Infrared links); within 10-15 meters (e.g. for Bluetooth); or within a wireless net's local range (e.g. if the Unit includes cell phone capability). The determining element is that the Unit can send a SM directly between a Sending and Receiving Unit without routing the SM through the SMS Central hardware and software.

Cultural Linkages The interpretive model guides constraining and guiding the correct process for deriving the full meaning of a message, both from its Core Text and contextual linkage, and from its Context Metadata, to ensure full communication from the process of sending and receiving the message, that is, that allow the meaning of the expression to be comprehended.

SM=Short Message A human-perceived communication, which typically requires interpretation that in turns requires knowledge of more information than that self-contained within the message, for proper comprehension. For example, the characters “U OWE 4 LNCH” cannot be deciphered using any formal language, even though a moderately-apt human user of slang will readily be able to transform them into the acceptable formal statement, “You owe {me=the message broadcaster} for lunch”.

SMS=Short Message Service A system for sending short messages (currently chiefly text, with some voice; potentially graphic, with some data) using existing communications infrastructure (hardware and software) from an input device through a network to one or more follower devices.

SMS Central At least one general-purpose computer whose hardware and software (including operating system and applications) create a functionally-distinct and functionally-specific machine allowing SM receipt, analysis, storage, comparison, augmentation, response, translation, and forwarding between a number of Sending and Receiving Units, wherein the originating and final versions of each SM is humanly-perceptible and recognizable, although the interim machine-transmitted versions may not be due to compression, coding, encipherment, or programming requirements.

Unit A device for creating, sending, displaying, and receiving Short Messages through wireless communication means, such as a cellular telephone with a display panel, a Blackberry or other SM-specific device, or a pager equipped with a display and entry capabilities.

User A person who uses the SMS to send at least one SM to one or more Followers; the human whom the technology is assisting keep in contact with friends, acquaintances, coworkers, family, and the rest of the world accessible through the SMS.

Overview

The typical desired use of any SMS is the exchange between already-associated individuals of a meaningful Short Message (SM) from the Broadcaster that can be correctly interpreted by its Follower. These messages are generally not merely informal, but also in a slang common to the broadcaster and follower. Isolated from its context (that is, without any knowledge of broadcaster and follower, time of message, and associational context), many a SM would be incomprehensible to a third party. This is viewed as a feature, not a bug, by many of the sub-communities (particularly teenagers) who are the heaviest SMS users.

It is possible sometimes to state general rules for deriving the meaning to be garnered from the Core Text. An example of such a general rule is that if the SM text makes no sense according to formal linguistic rules its individual letters and numerals should be sounded out phonetically and replaced by the closest phonemic, full-language equivalents. Thus, “C U 4 dinner” becomes “See you for dinner”; or, “I OWE U 4 lunch” becomes “I owe you for lunch”. Such replacement rules are both culturally differentiated and differentiating and encode (not encipher) meaning into a SM.

Many encoding rules, however, need the SM's Context Metadata to derive the meaning of the Core Text. A first and most basic example is that the Context Metadata includes the human identification of the Broadcaster and the Follower (as opposed to the machine identification of the Sending Unit and Receiving Unit). The Core Text that simply says, “I owe you for lunch” does not, absent its Contextual Metadata, identify either of the particular individuals to be associated with each of the pronouns. Knowing who is meant by “I” and “you”, requires the Context Metadata of ‘Broadcaster’ and ‘Follower’.

Other Context Metadata may also be needed. For example, if the Text says, “I will buy our next dinner”, knowing which dinner the broadcaster and follower are next to eat together is crucial. This may require the date and time of the message's sending; the combined current calendar up to the next joint meal date, or a regular pattern of a group that includes both individuals and a dinner. For example, this message, if sent just after the specified meal on a given date, or after the travel time needed to meet prohibits conjunction until after the standard time for such has passed, generally indicates that the meal will be on the following day at the earliest. Thus, ‘C U 4 lunch’ sent at 3:00 p.m. generally indicates that the next day's noon-time meal will be shared. Similarly, if the message itself indicated that the broadcaster and follower were in substantially different geographic locations at the sending early in the day, absent indication that the same people would be in the same location at a later, certain time before the planned meal, the ‘dinner’ becomes one set after the necessary travel time. Geographic as well as temporal location, and future plans, may become part of the Context Metadata.

Additionally, deriving the correct meaning may well require further knowledge of the cultural norm of the broadcaster and follower. In some cultures, “dinner” is the mid-day meal; in others, the evening meal; in others, the phrases “dinner” and “supper” may be interchangeable without differentiation; consider, for example, the confusion that can exist from a phrase such as “I'll buy you tea”, between American and British, or American and Indian, businessmen.

Finally, deriving the correct meaning may well require further knowledge of the particular patterns and habits of both the Broadcaster and the Follower. For example, two individuals both knowing the other is a late riser (being night-owl programmers), might well send ‘C U 4 lunch’ to get together to eat at 6 p.m. that day. But the same message, if sent at 19:00 (seven p.m.) to an East Coast American follower, only rarely communicates a meal on that day; while if sent mid-summer between two inhabitants of Madrid, Spain, almost certainly communicates that their meeting will take place before the date changes.

Thus, to be properly interpreted, a SM may require in addition to the Core Text the Context Metadata (broadcaster, follower(s), date and time sent, date and time received), and the cultural linkages for the parties (culture, age, and location) be made available to the follower. According to one embodiment it relieves the broadcaster from having to embed, and the follower to retrieve, either the Context Metadata or these cultural linkages, thereby lowering their communication burden while assisting the intended interpretation of the meaning of the SM. According to another embodiment it can prepare consequential future activity(ies) or response(s) appropriate to the received message in light of its intended effect. For example, a SM sent by a spouse on Feb. 13” saying “I LUV U” may generate a ‘back-message’ reminder to the broadcaster to come home bearing both flowers and a card after the business trip concludes the next day. In effecting these aspects may be described as an ever-helpful social secretary for (otherwise clueless) geeks.

A SMS may also enable communications between people of different subcultures whose limited yet shared contact means include the SMS as one part. According to another aspect, either party is provided the means to embed (on the part of the broadcaster) or retrieve (on the part of the follower) the cultural norms that will assist proper interpretation of the SM. This embedding can be either specific to the particular message, or associational by inclusion of ‘norms’ from a pre-provided cultural database. In this aspect, the SMS may be described as serving as a protocol secretary for non-diplomatic, cross-cultural associations.

A SMS can communicate informal, yet personal and important, messages which may require action or response on the part of the follower, For example, “HOW R U” (“How are you?”) or “ILUV” (“I love you”), both may well require a response, if only to show that the contact has been received. According to another embodiment, either party is provided the means to embed (on the part of the broadcaster) or retrieve (on the part of the follower) not only the cultural norms for proper interpretation of the SM itself but also the further norms for proper response (silence, sending of a response, making a personal visit, sending a card or sending flowers) and preparing them in advance of the next contact. In this aspect, the SMS may be described as serving as a response-making assistant for the otherwise less-than perfectly attentive, or simply non-forethoughtful, follower.

Finally, a SMS can embed its own functionally/directed coding schema to enable previously prepared, contextually-sensitive, short-range, locationally coincidental messaging between parties with prior contacts, obligations, or both, either coincident with contact with the remote and more comprehensive message processing capability or asynchronous updating thereof. In this aspect, the SMS may be described as providing co-locationally sensitive, immediate response assistance to a possibly inattentive or overloaded human user unable to instantly process or even detect all nearby perceivable appearances or presences.

Description of the Elements

The Broadcaster is the individual user initiating a SM. He (or she) does so on a Sending Unit, the hardware representing a physical link between human and system.

The Follower is the intended human target for the SM, and the Follower receives the SM on the Receiving Unit, itself a physical link between human and system.

It is possible that the Broadcaster and Follower are the same individual separated by time or time and locational difference (e.g. ‘Remind me when in Arlington to visit USPTO’).

A Sending Unit transmits a SM, either to SMS Central or, in an alternative embodiment, the Sending Unit may translate between Wireless Access Protocol (‘WAP’) and Internet Protocol using the Hyper Text Transfer Protocol (‘HTTP’), by translating a WAP POST to a HTTP Post before sending the SM to the SMS. In another alternative embodiment, the Sending Unit may send a response SM previously prepared by the SMS and posted to the Sending Unit, to a Receiving Unit detected by the Sending Unit within its Close Message Proximity (Bluetooth, UWB, or Wireless USB) distance.

For example, any Sending Unit having Close Message Proximity channel capability can have the SMS Central send to it a prepared SM with Context Metadata containing identification particular to that Sending Unit and a particular Follower. The Sending Unit can constantly test for the presence of a Receiving Unit associated with that particular Follower within the Sending Unit's Close Message Proximity. When an associated Receiving Unit is detected within the Sending Unit's Close Message Proximity, the Sending Unit can send the previously-prepared, particular Follower SM. This previously-prepared, Follower-specific SM may include notification that the SMS can be contacted for interpretative support. Then the Receiving Unit can contact the SMS for any necessary Context Metadata or cultural linkage support at the Follower's option.

In a further embodiment, if a previously-prepared SM is initiated by co-locality of Broadcaster and Follower, each unit may test its locality for the presence of the other unit and respond directly, without requiring the SMS Central to handle the exchange, though a copy of the exchange may be sent to the SMS. A database local to each Unit tracks and monitors co-location and correspondence and allows for direct interaction; though full analysis, comparison, and generation for any particular SM would still be handled by SMS. For example, Moe and Curly met for dinner on the first night, with Moe picking up the tab and Curly sending to Moe an SM saying “I 0 U 4 Dnr $23”. The SMS prepares a message for Curly's Sending Unit that says, “CUMGET YR $23” and returns it to be stored on Curly's Sending Unit. At the trade exhibition the next day Moe's Receiving Unit is detected by Curly's Sending Unit within Close Message Proximity, and the prepared SM “CUMGET YR $23” is sent along with Curly's current location. The message and storage could be reversed, so it is Moe's Unit that detects Curly's, the prepared SM reads “U 0 ME $23 CUM PAY”, and it is sent from Moe's to Curly's Unit.

In another, further, embodiment the SMS allows the Broadcaster to explicitly enter Context Metadata and then uses Context Metadata permutations entered by the Broadcaster that allow one or a set of contextual facts (e.g. time, date, location, the presence of specific other Users, or a previously-established pattern or cultural norm) to explicitly govern the sending of prepared SMs. For example, Curly may have prepared his reminding, automated SM to activate if and only if (Moe-within-Bluetooth-range=YES) and (Time is between 5:30 PM-7:30 PM PST); or if (Moe-within-Bluetooth-range=YES) and (Time is between 5:30 PM-7:30 PM PST) and (GPS Location=Los Angeles Airport Hilton, Calif., USA.) Alternatively, if Moe planned a party and used a first SM to contact his friends Larry, Curly and Shemp which read “u ome $12 4 beer if u come. rsvp w/cell #”, and all three did RSVP, then Moe could get the SMS to prepare a SM saying “u r here so pay me $12”, load it onto Moe's Sending Unit, and as any of Larry, Curly and Shemp arrive within Close Message Proximity-even if Moe's Unit only detects Shemp's cell phone with Shemp's cell phone number—then that person gets the billing message, as their presence and agreement is simultaneously noted by Moe's Unit.

In another embodiment the current GPS location for the Sending Unit is attached as Context Metadata, allowing geographical references to be used when examining or analyzing the SM and responding.

The SMS incorporates at least one central computer (SMS Central) having communications I/O capability for each Sending and Receiving Unit, memory, at least one database, the necessary operating system, and telecommunications and applications software for operation, as is known in the prior art. The SMS preferentially will have direct I/O capability for system monitoring, problem handling, and improvement independent of any particular Sending or Receiving Unit. The SMS also incorporates the software necessary for Core Text representation, storage, and decoding; and to provide Context Linkage, and in a further embodiment, Cultural Linkages analysis.

In a further embodiment the SMS Central includes a Cultural Database with patterns and data specific to the Broadcasters and Followers, allowing and enabling cross cultural comparisons and adaptations.

The SMS Central includes the software for analyzing the Core Text, said software having keyword scanning and identification capability and the equivalent of a Finite State Machine (FSM) for variable creation, use, and replacement with binding values. The SMS Central analyzing software also has the capability to use the Context Metadata and Cultural Linkage to provide variable binding and FSM pattern-matching as part of the SM message analysis process.

Additionally, the SMS Central includes software, for parsing the Core Text, such software including at least one Language Parser for the human-generated message (as distinct from the machine code representation of the original alphanumeric or iconic symbol string). The SMS Central may include a Language Parser designed for SMS Slang, and a Language Parser for different language representations (e.g. Roman and non-Roman alphabets, ideograms, hieroglyphics and icons), both formal and informal (an example of an informal, Latin-alphabet-punctuation based ‘alphabet’ are the common ‘emoticons’ developed in early text-based Internet precursor implementations, e.g. the smile (:-) ), big smile (:-}), the yell (:-O) and frown (:-( ).

In a further embodiment the SMS Central includes a pattern database for at least one set of cultural norms, whether such be of the Broadcaster, Follower, or both. In an alternative embodiment the SMS includes multiple databases with translation norms for multiple cultures. This pattern database can also incorporate the evolving set of common norms between a particular Broadcaster and a particular Follower, or a set of Broadcasters and Followers, arising from mutual interactions creating this new set of cultural norms through shared joint behavior and message forms. In another alternative, making explicit a determined cultural differentiation by display differentiation such as text color, ring tone, or previously stored choice by broadcaster or follower of an associated differentiation in representation according to cultural linkage (e.g. putting a briefcase icon before any SM from a ‘suit’, and a keyboard icon before any SM from a fellow programmer).

In a further embodiment, the SMS Central includes software that allows SM transmission and translation across at least two Alternative Cultural Norms (ACN), whether such be differentiated by the native language of the Broadcaster and Follower (English⇄Japanese), by the geographic locations of the Broadcaster, Follower, or both, or by the authorizing Unit (e.g. “Fujitsu's Global Hardware Division, Silicon Valley Branch”).

In a further embodiment the SMS Central includes software having pattern completion means which, through decoding and variable binding from one or more SMs, generates suggested responses to a received SM. For example, if a Broadcaster composes and transmits “UOM 45”, by comparing the present SM to previous exchanges between Broadcaster and Follower, SMS Central may generate the suggested inclusion of the currency mark so that the follower may receive “UOME $45”.

In a further embodiment the SMS includes software enabling translation across different media display capabilities. For most SMs, the most common current messaging means is using a hyperlink to context support information) using SMTP over the Internet. However, if the SMS detects that the Receiving Unit is a cell phone (using the Context Metadata), then the SMS may encode and transmit the original SM along with an additional SM notifying the Follower that contextual support is available from the SMS through a Wireless Access Protocol (‘WAP’) gateway. The SMS can send the context support message by using WAP GET, translated to HTTP GET by the Follower's WAP gateway. The Follower then may decide whether or not to engage additional software necessary to translate the differential media (sound, graphic, or different alphabet), in the fashion like to that used for current Multi-Media Messaging (‘MMS’).

This may, for example, be done if the Follower is a cell number, with the Sending Unit also sending an additional SM notifying the SMS, which then sends to Follower a further SM, by downloading the context-support message from the SMS using Wireless Access Protocol (‘WAP’) GET but translating it to an HTTP GET by the WAP gateway, before it reaches MMC.

In a further embodiment, the SMS Central includes software generating additional linked information that enhances the context available but not specifically incorporated in the original SM. An example of such would the be inclusion of a ‘return receipt’ SM that would, upon confirmation of a successful transmission to the Receiving Unit, notify the Broadcaster of a completed and therefore now-available communication between Sending and Receiving Units, or in a further embodiment, of actual activation and thus presumed reading of the SM by the Follower.

In yet a further embodiment, the SMS Central includes software for comparing the Core Text to Third-Party offers stored in the database as open-ended messages to which both Broadcaster and Follower match the intended offerees of the Third Party, upon analysis of the Core Text, Context Metadata and Cultural Linkages of the SM. For example, Broadcaster's SM may contain Broadcaster's offer to buy lunch for Follower. The Context Metadata may show that the offer is good within a particular city (e.g. Austin, Tex.) and within a particular date range (Oct. 10-14, 2005). A Third-Party may have already sent a SM to SMS Central, indicating that any SMS user in Austin in October, 2005 can get a 20% discount on a lunch a particular restaurant, chain of restaurants, or set of restaurants. The SMS Central, having matched the time, date, location, and intentions of the particular Broadcaster and Follower to the Third Party's qualifying criteria, can now add to Broadcaster's original SM the Third Party's offer, and copy back from SMS Central to the Sending Unit the same offer from the Third Party, with both Broadcaster and Follower both being notified that the Third Party's offer has been made common knowledge between the three Users.

In yet a further embodiment the SMS includes software that measures the entire SM, including the Core Text, Context Metadata, and Cultural Linkages, against formalization norms contained in the database to determine the extent to which the SM matches any such norm and thus can be said to have committed the Broadcaster to an informal contract, formal contract, or fully-binding and even assignable commitment.

According to one embodiment the SMS suggests a response that will match one or more partially-completed formal norms. Further, the SMS is allowed to send at least one additional message to the parties, signaling the completion of any formal norm. In addition, the SMS is allowed to analyze and compare the partially-created pattern against a matching set of potential completed patterns and suggest one or more inferential further operations that would complete such pattern. A yet further extension allows the SMS to indicate when the absence of any overt responsive effort will passively allow, through automatic means—for example, those requiring no further action by the Broadcaster such as the passage of time—the creation of a formalization norm. A yet further extension allows the SMS to store a completed formalization norm and to allow each of the parties to consult the SMS to examine the state of all relevant stored formalization norms involving that party.

According to one embodiment, the field of forming is expressly disclaimed, through its own activities, any such binding formal commitment without the active participation and interpretation of the results by the minimum set of broadcaster(s) and follower(s), as the focus of is on supporting the less-than-formal commitments and ties which join individuals into a community, despite differences in language, communication means, or cultural contexts. In yet another embodiment, the SMS may offer the party closest to converting the less-than-formal commitment into a final commitment, advice as to either strengthening, or deliberately removing, such from the dealings between the two parties.

In addition, when a culturally-supported, even though less than formal commitment has been instantiated through the SMS, it additionally provides both an explicit record of the less-than-formal commitment, and can link the broadcaster, follower, or both to the goods and services of a third party who may wish to offer the same to the communicants. BEST MODE

A Broadcaster uses his Sending Unit to send an SM to a Follower(s). Upon receiving a SM the SMS Central decodes the message data, stores the message data to an array, parses the data array according to specified headers, and extracts selected information (i.e. destination address, message keywords, date and/or time stamps) that generates the Context Metadata.

Both the Core Text and Context Metadata are associated with the Broadcaster and Follower(s) and stored in a database, and forwarded to the Follower(s) using standard SMS messaging means, including forwarding text messages to graphic displays and/or substituting voice for text or text for voice messages according to the receiving unit(s) functionality. No claim is made for either the message forwarding or use of substitute media by the SMS, as each is believed established in the prior art.

The extracted data is run through software which analyzes and stores associations created by the SM to the database. The combined Core Text and Context Metadata are compared to existing patterns, seeking to match other unfilled message pattern needs; if a match is made, then the additional pattern, in the form of its Context Metadata and Core Text, is both associated with the SM and sent back to the Broadcaster.

If a translation (across media, hardware, or cultural linkage) has been made, then a message indicating the availability of context support by the SMS is also sent to the Follower(s). At the request of the Follower, the Context Metadata will be both translated into the same form as the Core Text and explicitly displayed in association with the Core Text.

For example, Joe, upon receiving a voicemail message saying, “Hello, Joe”, send from Ed to Joe could ask for its display in the form “From Ed: ‘Hello, Joe’; message sent 9:57 AM PDT from Santa Maria, Calif.” If Joe specified the message was to appear in text on his pager display (Joe being in court), the text could scroll across the pager's display; or if Joe specified that the message was to be made vocally, a speech synthesizer would replace Ed's Core Text with a synthesized voice-which might be associated by Ed with his message, or by Joe with Ed's name.

The SMS software further analyzes the combined Core Text and Context Metadata according to the Cultural Linkages associated with the Core Text. This association may be specified by the Broadcaster, specified by the Follower; or may be inferred by the SMS from prior associational linkages previously established between the Broadcaster and Follower (i.e. from this Ed and to this Joe). This analysis compares the combined Core Text, Context Metadata, and Cultural Linkages against pre-existing patterns identified in the SMS database; seeks out matches; and ranks matches found by relative strength of match. Finally, the combined Core Text and Context Metadata are run through the SMS software analyzing the Cultural Linkages appropriate to each of the Broadcaster and Follower(s) and, to the extent that a translation is made a notice to both Broadcaster and Follower(s) thereof is prepared and sent to the respective Units.

Finally, if the SMS software detected a pattern matching a formalization norm (such as being the final message in a four-part exchange of offer, counter-offer, counter-counter offer, and final acceptance), then the SMS sends notification of meeting such a formalization norm to the Broadcaster and Follower.

FIG. 9 is a process flow that illustrates processing the short message through a microblog search engine, according to one embodiment. In operation 902, a short message between a broadcaster 19 and follower 20 may be accessed through a first microblog server. In operation 904, the short message may be parsed with the microblog search engine. In operation 906, a context metadata of the short message may be generated. In operation 908, the context metadata may be explicitly associated to the short message. In operation 910, the short message and the context metadata may be delivered to a requester through the microblog search engine.

FIG. 10 is a process flow that illustrates sending a short message to a follower, according to one embodiment. In operation 1002, a short message intended for particular follower may be stored on a first unit. In operation 1004, a core text and a context metadata may be associated. In operation 1006, a receiving unit that indicates the context metadata to be within close message proximity of the first unit may be detected and associated with the particular follower. In operation 1008, the short message may be communicated to the receiving unit. In operation 1010, a notification that the short message has been sent to the particular follower may be communicated to the server.

While these aspects have been described in reference to illustrative embodiments, this description is not to be construed in a limiting sense. Various modifications and combinations of the illustrative embodiments as well as other embodiments will be apparent to those skilled in the art upon referencing this disclosure. It is therefore intended this disclosure encompass any such modifications or embodiments. Furthermore, the scope includes any combination of the elements from the different embodiments disclosed in this specification, and is not limited to the specifics of the preferred embodiment or any of the alternative embodiments mentioned above. Individual user configurations and embodiments may contain all, or less than all, of the elements disclosed in the specification according to the needs and desires of that user. The claims stated herein should be read as including those elements which are not necessary yet are in the prior art and are necessary to the overall function of that particular claim, and should be read as including, to the maximum extent permissible by law, known functional equivalents to the elements disclosed in the specification, even though those functional equivalents are not exhaustively detailed herein.

Although the present aspects have has been described chiefly in terms of the presently preferred embodiment, it is to be understood that the disclosure is not to be interpreted as limiting. Various alterations and modifications will no doubt become apparent to those skilled in the art after having read the above disclosure. Such modifications may involve other features which are already known in the design, manufacture and use of Short Message Systems, both hardware and associated software therefore, and which may be used instead of or in addition to features already described herein. The examples herein are not limiting but instructive of the embodiment, and variations which are readily derived through programming or embedded hardware transformations which are standard or known to the appropriate art are not excluded by omission. Accordingly, it is intended that the appended claims are interpreted as covering all alterations and modifications as fall within the true spirit and scope of the claims in light of the prior art.

Additionally, although claims have been formulated in this application to particular combinations of elements, it should be understood that the scope of the disclosure of the present application also includes any single novel element or any novel combination of elements disclosed herein, either explicitly or implicitly, whether or not it relates to the same embodiments as presently claimed in any claim and whether or not it mitigates any or all of the same technical problems as does the present embodiments. The applicants hereby give notice that new claims may be formulated to such features and/or combinations of such features during the prosecution of the present application or of any further application derived there from.

What is claimed is:

1. A computer-implemented method comprising:
accessing a short message between a broadcaster and at least one follower through a first microblog server;
processing the short message through a microblog search engine, the processing further comprising:
parsing the short message with the microblog search engine;
generating a context metadata of the short message;
associating explicitly the context metadata to the short message; and
delivering the short message and the context metadata to a requester through the microblog search engine.

2. The computer-implemented method as in claim 1, further comprising:
translating between a Wireless Access Protocol (WAP) and an Internet Protocol by translating a WAP POST to a HTTP POST before sending the short message from the WAP unit to the first Microblog Server;
translating a WAP GET to a HTTP GET before sending any short message from the microblog server to a WAP unit;
allowing the requester to explicitly enter the context metadata;
using a permutation of the context metadata entered by the requester to explicitly govern a search operation of a prepared short message;
automatically attaching a current Global Positioning System (GPS) location of the broadcaster as the context metadata;
storing the short message and the context metadata;
identifying the broadcaster;
comparing the broadcaster against a database containing previous broadcasters;
incorporating the broadcaster into the database;
identifying a follower;
comparing the follower against a database containing previous followers;
incorporating the follower into the database;
analyzing a parsed short message and the context metadata to identify at least one key token;
comparing each identified key token against a database containing a previous key tokens, the database containing each previous key token and an association between each key token and the broadcaster;
incorporating into the database each identified key token the association between each key token and the broadcaster;
analyzing the parsed short message and the context metadata to identify at least one message structure pattern;
comparing each identified message structure pattern against a database of previous message structure patterns, the database containing each previous message structure pattern and a respective association between the respective association and the broadcaster; and
incorporating into the database each identified message structure pattern and the respective association.

3. The computer-implemented method as in claim 2, further comprising:
searching through the database an offer matching at least one key token, the offer coming from a third party;
attaching the offer to the short message and the context metadata;
sending the short message and the context metadata and the offer to the requester;
creating a response of the short message and the context metadata with an attached offer; sending the response of the short message and the context metadata with the attached offer back to the requester along with microblog search results through the microblog search engine;
searching the database for each offer matching at least a message structure pattern of the short message, each said offer coming from a third party; and, upon finding any offer matching at least a message structure pattern of the short message:
attaching the offer to the short message and the context metadata;
sending the short message and the context metadata and the offer to the requester;
creating a duplicate of the short message and the context metadata with the attached offer; and
sending the duplicate of the short message and the context metadata with the attached offer back to the broadcaster.

4. The computer-implemented method as in claim 3, further comprising:
searching the database containing the previous broadcasters periodically and for each previous broadcaster;
retrieving each stored short message and the context metadata sent by the broadcaster;
passing a retrieved short message and the context metadata sent by the broadcaster through a text analyzer;
analyzing the text and context metadata;
identifying a date and a time element of the short message; comparing the current date and time to the date and the time element of the context metadata; and,
determining whether the text and context metadata represents an uncompleted commitment, and if so;
generating a follow-up message;
sending a follow-up message to the broadcaster; and identifying a user who is responsible for taking action at or before a particular date and time; and, upon determining that the text and context metadata represents an uncompleted commitment, the Server generates and sends the follow-up message to that user,
wherein the operation of processing the short message through at least one server further comprising analyzing the short message and an associated context metadata for a cultural linkage by comparing the short message and the associated context metadata to a cultural database with a patterns and a data specific to a users of the microblog search engine.

5. The computer-implemented method as in claim 4, wherein the server includes at least two different cultural databases; and further comprising:
comparing the short message and the associated context metadata to each cultural database with patterns and data specific to the user of the microblog search engine until finding a broadcaster's cultural database containing the closest match to the requester;
comparing the short message and associated context metadata to each cultural database with patterns and data specific to users of the microblog search engine until finding a requestor's cultural database containing the closest match to the requester;
comparing the short message according to a translation norm for translating the short message from the broadcaster's cultural database to the follower's cultural database;
incorporating an evolving set of common norms between a particular broadcaster and a particular follower arising from mutual interactions creating this new set of cultural norms through shared joint behavior and message forms;
making explicit a determined cultural differentiation by display differentiation according to a cultural linkage, wherein the operation of parsing the short message further comprises using a language parser designed for a short message service slang;
using a language parser for different language representations including at least two distinct language representations, wherein a first language representation is for a standard alphabetic language and a second language representation is an informal, character-derived, compilation of a known emotional associations of a particular punctuation grouping;
using a software application that allows a short message transmission and a short message translation across at least two alternative cultural norms,
wherein the short message transmission and the short message translation across at least two alternative cultural norms comprises using software that allows the short message transmission and the short message translation across at least two different human languages,
wherein the short message transmission and the short message translation across at least two alternative cultural norms comprises using the microblog search engine to provide translation across at least two different alternative cultural norms distinguished by a respective geographic locations of the broadcaster and the follower;
using a pattern-completion application of the microblog search engine to decode and to variably bind from one or more short messages;
generating a suggested search result to a received short message search query;
using an enabling translation across a different media display capability through the microblog search engine, wherein the operation of applying the translation across the different media display capability comprises, for translating between an Internet and a cell phone short message:
when moving from a Wireless Access Protocol (WAP) to the internet: for each WAP GET, substituting a HTTP GET; and, for each WAP POST, substituting a HTTP POST; and, when moving from Internet to WAP:
for each HTTP GET, substituting a WAP GET; and, for each HTTP POST, substituting a WAP POST;
sending to the requester a further short message by downloading the context-support message from the short message search service from the microblog search engine; and
generating an additional linked information that enhances the context available but is not specifically incorporated in the original short message.

6. The computer-implemented method as in claim 5, wherein the operation of generating additional linked information that enhances the context available but is not specifically incorporated in the original short message further comprises including a return receipt short message that would, upon confirmation of a successful transmission to the receiving unit, notify the broadcaster of a completed and therefore now-available communication between a sending microblog server and a receiving microblog server.

7. The computer-implemented method as in claim 6, further comprising:
sending the return receipt short message to the original broadcaster upon actual activation, and thus presumed reading, of the short message by the follower; and
comparing the core text to third-party offers stored in the database as open-ended messages to which both broadcaster and follower match intended offers of the third party, upon analysis of the core text, context metadata and cultural linkages of the short message.

8. The computer-implemented method as in claim 7, further comprising:
measuring the entire short message, comprising the core text, the context metadata, and the cultural linkages, against a formalization of norms contained in the database to determine the extent to which the short message matches any such formalization norm;
permitting the microblog search engine to suggest a response that matches at least one partially-completed formal norms;
permitting the microblog search engine to send at least one additional message to signal the completion of any formal norm;
analyzing and comparing the partially-created pattern against a matching set of potential completed patterns; and
suggesting for each potential completed pattern at least one inferential further operation that would complete that potential completed pattern.

9. The computer-implemented method as in claim 8, further comprising permitting the microblog search engine to indicate when an absence of any overt responsive effort to passively allow the creation of a formalization norm.

10. The computer-implemented method as in claim 9, wherein the microblog search engine, after processing the short message, offers the party closest to converting the less-than-formal commitment into a final commitment, an advice as to either strengthening, or removing, such from the dealings between the two parties.

11. The computer-implemented method as in claim 10, wherein the operation of processing the short message through at least one server further comprises, when a culturally-supported even though less than formal commitment has been instantiated through the microblog search engine, having the short message service provide both an explicit record of the less-than-formal commitment, and link the broadcaster and the follower to a good and a service of a third party.

12. A computer-implemented method whereby a microblog search engine provides contextual support for a short message search across a plurality of microblog servers, the method comprising:
storing on a first unit a short message intended for at least one particular follower, said the short message having already been:
previously prepared by and sent from a server;
associating a core text and a context metadata;
detecting a receiving unit that the context metadata indicates to be within a close message proximity of the first unit and associated with the particular follower;
communicating the short message to the receiving unit; and
communicating to the server a notification that the short message has been sent to the particular follower.

13. The computer-implemented method as in claim 12, further comprising:
adding to the short message a notification that the microblog search engine is configurable for interpretative support;
permitting each of the first microblog server and a second microblog server to test the/a respective locality for the presence of a different broadcaster; and, upon detection of a mutual close message proximity;
permitting direct exchange of the short message service between the first microblog server and the second microblog server;
sending to the server a copy of each short message plus a associated context metadata directly exchanged between the first unit and the second unit; and, processing the short message the server, said processing further comprising parsing the short message;
generating the short message context metadata; and
associating explicitly the context metadata to the short message.

14. A microblog search application comprising:
a first interface configured to facilitate composition of a message by a requesting user;
logic to automatically generate a search query based on the message; and
a second interface configured to:
display search results relating to the search query; and
receive selections of the search results from the user, the microblog search application automatically incorporating, in response to the selections, the selected ones of the search results into the message in the first interface.

15. The microblog search application of claim 14 wherein the automatically generate the search query is through a contextual association between the message of the requesting user and a database associated with a comparative analyzer of the microblog search engine.

16. The microblog search application of claim 15, wherein the microblog search application additionally comprises:
logic to submit the generated search query to a context associator of the microblog search engine.

17. The microblog search application of claim 16, wherein the context associator includes a web search component, an image search component, a video search component, a local search component, a geographic search component, a product search component, a listing search component, an email search component, a blog search component, a message group search component, a news search component, a digitized content search component, a desktop search component, or an advertisement search component.

18. The microblog search application of claim 17, wherein the generated search query is submitted to a plurality of microblog servers that each provide broadcast short message services to any number of broadcasters, each associated with a set of followers.

19. The microblog search application of claim 18, wherein a geospatial contextual information is automatically associated with the search result through a context associator of the microblog search engine, wherein geospatial coordinates of at least one of a broadcasting device and a follower device is automatically provided to a microblog server associated with the microblog search engine through a global positioning network communicatively coupled to at least one of the broadcasting device and the follower device.

20. The microblog search application of claim 19, wherein a trending data is automatically associated with the search result through the context associator, wherein the trending data is determined through a semantic analysis of the message with a database associated with the comparative analyzer that includes an association based on a linguistic characteristic of the message with records of the database, and wherein a recommended set of trending terms are suggested to the requesting user of the microblog search engine when the semantic analysis is complete.

21. The microblog search application of claim 20 wherein a temporal data is associated with each short message indexed by the microblog search engine, and wherein the temporal data is derived through a time stamp associated with each short message provided by at least one of a broadcaster device and a follower device communicatively coupled with the microblog search engine.

22. The microblog search application of claim 21 wherein the search results include individual microblog messages that match the search query and which are posted in at least one microblog server communicatively coupled to the microblog search engine.

23. The microblog search application of claim 22 wherein the individual microblog posts are limited to approximately 140 to 160 characters.

24. The microblog search application of claim 23 wherein the individual microblog posts are broadcasted to any number of follower devices which have voluntarily subscribed to feeds of a broadcaster device that generates the individual microblog posts, and wherein a particular follower device responds to a particular individual microblog post directly to at least one of the broadcaster device of the particular individual microblog post and followers of the particular follower device.
